(19) United States
(12) Patent Application Publication
(10) Pub. No.: US 2008/0014469 A1
(43) Pub. Date: Jan. 17, 2008

(54) Method for cleaning a glass substrate, method for fabricating a glass substrate, and magnetic disk using the same

(76) Inventors: Hideki Kawai, Kobe-shi (JP); Yukitoshi Nakatsuji, Osaka (JP); Hiroaki Sawada, Osaka (JP); Shinichi Saeki, Osaka (JP)

Correspondence Address: BRINKS HOFER GILSON & LIONE, P.O. BOX 10395, CHICAGO, IL, 60610, US

(21) Appl. No.: 11/824,770

(22) Filed: Jul. 2, 2007

(30) Foreign Application Priority Data
Jul. 3, 2006 (JP) 2006-183085

(51) Int. Cl. G11B 5/66; B08B 3/04; C03B 8/00

(52) U.S. Cl. 428/848; 134/34; 65/62

(57) ABSTRACT

A method for cleaning a glass substrate containing SiO₂ as a main ingredient thereof ensuring removal of abrasive and foreign matter adhered to the glass substrate after a polishing step, without complicating a cleaning step, including a process in which the glass substrate is cleaned by scrubbing using a liquid having Si element stationary in a range from 1 to 5 000 ppb/mm².

This application is based on Japanese Patent Application No. 2006-183085 filed on Jul. 3, 2006, and the contents of which are hereby incorporated by reference.

### BACKGROUND OF THE INVENTION

1. Field of the Invention

The present invention relates to a method for cleaning a glass substrate. More particularly, the present invention relates to a method for cleaning a glass substrate by scrubbing, to a method for fabricating a glass substrate in which the glass substrate is cleaned by the cleaning method and to a magnetic disk using a glass substrate so cleaned and fabricated.

2. Description of Related Art

Conventionally, as substrates for magnetic disks, there have generally been used aluminum substrates in stationary devices such as desktop computers and servers, and glass substrates in portable devices such as notebook computers and mobile computers. One disadvantage with aluminum substrates is that they are easy to deform and are not hard enough, offering not quite satisfactory smoothness on the substrate surface after polishing. Another disadvantage is that, if a magnetic head happens to touch a magnetic disk, the magnetic film on an aluminum substrate is prone to exfoliate from the substrate. Under this background, it is expected that glass substrates, less prone do deformation, offering better surface smoothness, and affording higher mechanical strength, will be increasingly used not only in portable but also in stationary devices and in other home information appliances.

The recording capacity of a magnetic disk can be increased by reducing the distance between the surface thereof and a magnetic head. Inconveniently, however, with a reduced distance between a magnetic head and the surface of a magnetic disk, if there is an abnormal projection formed on or foreign matter adhered to the surface of a glass substrate, the magnetic head collides with the projection or foreign matter. Thus, to make it possible to increase the recording capacity of a magnetic disk by reducing the distance from the surface thereof to a magnetic head, it is necessary to eliminate formation of projections on and adhesion of foreign matter to the surface of a glass substrate altogether. For this purpose, it is conventional practice to polish the surface of a glass substrate with abrasive such as cerium oxide to make it smooth enough.

Disadvantageously, however, polishing a glass substrate with abrasive may leave the abrasive firmly adhered to the surface thereof, and even when the glass substrate surface is thereafter cleaned by scrubbing, it is difficult to remove the abrasive firmly adhered thereto. Moreover, forming a magnetic recording layer on the glass substrate surface with the abrasive firmly adhered thereto is likely to produce pin holes in the layer, destabilize the floating characteristics of the head, and otherwise significantly degrade the magnetic recording characteristics.

As a solution, for example, JP-A-2002-074653 proposes performing, after a polishing step, three types of cleaning, namely ultrasonic cleaning using a detergent, cleaning by scrubbing, and ultrasonic cleaning using pure water. As another solution, JP-A-2003-228824 proposes cleaning a glass substrate by a combination of cleaning by scrubbing and cleaning using a water solution of carbon dioxide.

Supposedly, these conventionally proposed technologies help to a certain degree to remove the abrasive adhered to a glass substrate. Disadvantageously, however, the former technology, requiring three types of cleaning, complicates the cleaning step and lowers productivity; likewise, the latter technology, requiring the introduction of equipment for maintaining and managing the solubility of the gas, complicates the cleaning step and lowers productivity.

### SUMMARY OF THE INVENTION

In view of the above described problems, it is an object of the present invention to provide a method for cleaning a glass substrate that, without making a cleaning step complicated, ensures removal of abrasive and foreign matter adhered to the glass substrate after a polishing step and leaves the glass substrate after the cleaning step clean and free of residual cleaning liquid ingredients.

It is another object of the present invention to provide a method for fabricating a glass substrate, and a magnetic disk using a glass substrate so fabricated, that allows an increase in recording capacity through a reduction of the distance between a magnetic head and the surface of the magnetic disk.

An intensive study in search of the way to achieve the above object has led the inventors of the present invention to discover that the aim is attained by using, as a cleaning liquid, a liquid having Si element stationary in a predetermined range and using, as a cleaning method, scrub-cleaning.

One of the distinctive features of the cleaning method of the present invention is that a glass substrate is cleaned by use of, as a cleaning liquid, a liquid having Si element stationary in a predetermined range. This allows abrasive and foreign matter firmly adhered to the glass substrate surface to somewhat float, and thereby ensures that the abrasive and foreign matter are removed from the glass substrate surface by scrub-cleaning.

Specifically, according to one aspect of the present invention, in a method for cleaning a glass substrate, a glass substrate containing SiO₂ as a main ingredient thereof is cleaned by scrubbing using a cleaning liquid having Si element stationary in the range from 1 to 5 000 ppb/mm².

Preferably, the Si element stationary is in the range from 2 to 3 000 ppb/mm².

Preferably, the cleaning liquid is hydrofluoric acid.

According to another aspect of the present invention, a method for fabricating a glass substrate includes a cleaning step using the cleaning method described above.

According to yet another aspect of the present invention, a magnetic disk has a magnetic recording layer formed on a glass substrate fabricated by the fabrication method described above.

The method for cleaning a glass substrate according to the present invention uses, as a cleaning liquid, a liquid having Si element stationary in the range from 1 to 5 000 ppb/mm². This allows the glass substrate surface to be slightly eroded, and thereby allows abrasive and foreign matter firmly adhered to the glass substrate surface to somewhat float. It is thus ensured that the abrasive and foreign matter, in a somewhat floating state, are removed by scrub-cleaning.

In the method for fabricating a glass substrate according to the present invention, the glass substrate is cleaned by the above cleaning method, and as a result abrasive and foreign matter is removed from the glass substrate surface. This simplifies the cleaning step, and improves productivity.

The magnetic disk according to the present invention has a magnetic recording layer formed on a glass substrate fabricated by the above fabrication method. This makes it possible to reduce the distance between a magnetic head and the surface of the magnetic disk, and thus to increase the recording capacity thereof.

### BRIEF DESCRIPTION OF THE DRAWINGS

FIG. 1 is a diagram schematically showing an example of scrub-cleaning equipment; and

FIG. 2 is a diagram showing an example of a process for fabricating a glass substrate and a magnetic disk according to the invention.

### DETAILED DESCRIPTION OF PREFERRED EMBODIMENTS

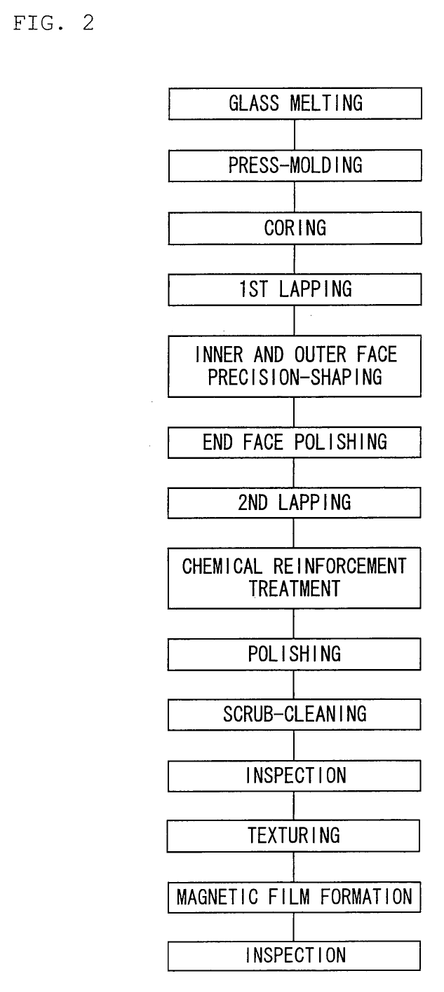

FIG. 2 shows an outline of, in one part, an example of a process for fabricating a glass substrate involving scrub-cleaning and, in the other part, a process for fabricating a magnetic disk using a glass substrate so fabricated. First, a glass material is melted (a glass melting step). The melted glass is then poured into a lower mold, and is then molded by being pressed with an upper mold into a disk-shaped glass substrate precursor (a press-molding step). Here, the disk-shaped glass substrate precursor may be formed, instead of by press-molding, by cutting it with an abrasive grindstone out of sheet glass formed, for example, by down-drawing or floating.

There is no particular restriction on the material of the glass substrate targeted by the cleaning method of the present invention. Examples of the material include: soda-lime glass, of which the main ingredients are silicon dioxide, sodium oxide, and calcium oxide; aluminosilicate glass, of which the main ingredients are silicon dioxide, aluminum oxide, and R₂O (where R═K, Na, Li); borosilicate glass; lithium oxide-silicon dioxide glass; lithium oxide-aluminum oxide-silicon dioxide glass; R′O-aluminum oxide-silicon dioxide glass (where R′═Mg, Ca, Sr, Ba). Any of these glass materials may have zirconium oxide, titanium oxide, or the like added thereto.

There is no particular restriction on the size of the glass substrate. The method of the present invention is applicable to 2.5-inch, 1.8-inch, 1-inch, and 0.85-inch disks and even disks with smaller diameters, and to 2 mm thick, 1 mm thick, and 0.63 mm thick disks and even disks with smaller thicknesses.

As necessary, in a central portion of the press-molded glass substrate precursor, a hole is formed with a core drill or the like (a coring step). Then, in a first lapping step, the surface of the glass substrate on both sides is ground, and thereby the overall shape of the glass substrate is preliminarily adjusted in terms of the parallelism, flatness, and thickness thereof. Next, the outer and inner circumferential edge faces of the glass substrate are ground and chamfered, and thereby fine adjustments are made in the exterior dimensions and roundness of the glass substrate, the inner diameter of the hole, and the concentricity between the glass substrate and the hole (an inner and outer face precision-shaping step). Then, the outer and inner circumferential edge faces of the glass substrate are polished to remove minute scratches and the like (an end face polishing step).

Next, the surface of the glass substrate on both sides is ground again, and thereby fine adjustments are made in the parallelism, flatness, and thickness of the glass substrate (a second lapping step). Then, to improve the mechanical strength of the glass substrate, it is subjected to chemical reinforcement treatment. In the chemical reinforcement treatment here, the glass substrate is immersed in a chemical reinforcement liquid collected in a chemical reinforcement treatment vat so that the alkali metal ions on the glass substrate surface are substituted by alkali metal ions with larger ion diameters. This produces compression strain and thereby improves mechanical strength.

Next, the surface of the glass substrate on both sides is polished, and thereby the surface irregularities on the glass substrate surface are leveled. As necessary, the surface of the glass substrate on both sides may be further polished with abrasive having a different grain size. In the present invention, the step of polishing the glass substrate is achieved with a conventionally known technology as it is. To polish the glass substrate, for example, two rotatable surface plates are arranged opposite each other, and pads are attached one to each of the faces thereof that face each other; then, the glass substrate is placed between the two pads, and the surface plates are rotated with the glass substrate surface kept in contact with the pads, while abrasive is supplied to the glass substrate surface. Examples of the abrasive include: cerium oxide, zirconium oxide, aluminum oxide, manganese oxide, colloidal silica, and diamond. Among these, using cerium oxide is recommendable because it reacts well with glass and produces a smooth polished surface in a short time.

To effectively remove the abrasive, foreign matter, and the like on the glass substrate surface, it is preferable that the glass substrate be kept in contact with the same liquid as the cleaning liquid described above before scrub-cleaning. There is no particular restriction on the duration of contact. To let the liquid exert a slight eroding action adequate to allow the abrasive and foreign matter firmly adhered to the glass substrate surface to somewhat float, it is preferable that the duration of contact be 10 minutes or more. On the other hand, the longer the duration of the contact of the glass substrate with the liquid, the easier the removal of the abrasive and foreign matter from the glass substrate surface, but the lower the productivity of the glass substrate. Thus, a preferable range of the duration of contact is from 5 to 30 minutes. For effective prevention of adhesion of foreign matter to the glass substrate surface, it is recommended that the glass substrate is kept in contact with the liquid until immediately before scrub-cleaning.

As the method for keeping the glass substrate surface with the liquid, any conventionally known one may be adopted. Examples of such methods include: one in which the glass substrate is immersed in the liquid collected in a container; one in which the glass substrate is sprayed with the liquid; and one in which the glass substrate is coated with cloth impregnated with the liquid. Among these, the method involving immersion of the glass substrate in the liquid is preferable because it ensures that the entire glass substrate surface is evenly kept in contact with the liquid.

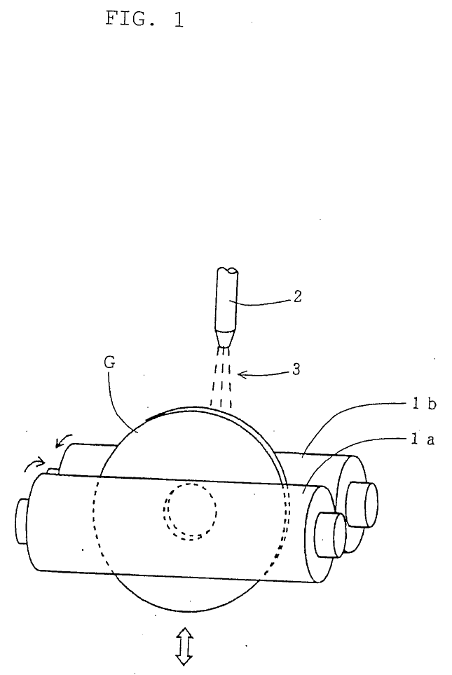

An example of scrub-cleaning equipment is shown in FIG. 1. In the scrub-cleaning equipment shown in FIG. 1, a glass substrate G is placed at the nip between a pair of sponge rollers la and lb pressed against each other, and, while a cleaning liquid 3 is sprayed from a nozzle 2 arranged above, the sponge rollers 1a and 1b are rotated in opposite directions relative to each other; simultaneously, the glass substrate G itself is also moved up and down. In this way, the entire surface of the glass substrate on both sides is cleaned.

Scrub-cleaning is performed under the following conditions. The two rollers 1a and 1b may be rotated at an equal rate, or at different rates as necessary. A typical range of the rotation rate of the rollers is from 10 to 500 rpm, and more preferably from 30 to 300 rpm. A typical range of the rate of movement of the glass substrate G is from 0 to 50 times per minute, and more preferably from 5 to 30 times per minute. A typical range of the feed rate of the cleaning liquid 3 is from 10 to 1 000 ml per minute, and more preferably from 50 to 500 ml per minute. A typical range of the duration of scrub-cleaning is from 5 to 150 seconds, and more preferably from 10 to 100 seconds.

Needless to say, scrubbing may be achieved, instead of with sponge rollers as shown in FIG. 1, with any other members such as brushes or pads as conventionally known. Examples of the material of such scribing members include: polyvinyl alcohol, polyurethane, vinyl alcohol, polypropylene, and nylon.

The cleaning liquid used in the present invention has Si element stationary in the range from 1 to 5 000 ppb/mm². If the cleaning liquid has Si element stationary less than 1 ppb/mm², it is impossible to allow the abrasive and other foreign matter firmly adhered to the glass substrate surface to sufficiently float, and thus it is impossible to perform scrub-cleaning effectively. On the other hand, Si element stationary more than 5 000 ppb/mm² causes the glass substrate surface to be eroded too quickly, and thus makes the control of the cleaning duration difficult, resulting in a rough surface; it also leaves a residue on the surface, possibly leading to degraded magnetic characteristics in the magnetic layer that will be formed on the substrate. A more preferable range of the Si element stationary of the cleaning liquid is from 2 to 3 000 ppb/mm². Examples of the cleaning liquid used in the present invention include: hydrofluoric acid, sodium hydroxide, and sodium silicate. Among these, hydrofluoric acid is particularly suitable because it has a high Si element stationary.

In the present invention, the elution of the Si element into the liquid is measured in the following manner. First, a reference glass substrate is prepared from aluminoborosilicate glass containing SiO₂ as a main ingredient thereof and having the following composition: 65% by weight of SiO₂, 15% by weight of Al₂O₃, 5% by weight of B₂O₃, 2% by weight of Li₂O, 7% by weight of Na₂O, and 6% by weight of K₂O. The main surface of this substrate is polished with cerium oxide to have a surface roughness of 20 Å or less, and is then cleaned, the reference glass substrate eventually having an outer diameter of 65 mm, an inner diameter of 20 mm, and a thickness of 0.635 mm. This glass substrate is immersed in 250 ml of the liquid kept at 60° C. for five hours. Then, on an ICP (inductively coupled plasma) atomic emission spectrometer, the amount of the Si element in the elution liquid is measured. In advance, the amount of the Si element in the liquid before the immersion of the glass substrate is measured likewise so that this amount is subtracted from that measured after immersion, and, based on the result of this subtraction, the Si element stationary of the liquid is calculated.

As necessary, the glass substrate that has undergone scrub-cleaning is then subjected to drying (unillustrated). Specifically, for drying, the glass substrate is immersed in IPA (isopropyl alcohol) so that cleaning liquid ingredients dissolve into IPA and that the liquid coating the substrate surface is substituted by IPA; thereafter, while the glass substrate is exposed to IPA vapor, IPA is vaporized and thereby the glass substrate is dried. Thereafter, as necessary, the glass substrate is inspected. The glass substrate may be dried otherwise than just described; it may be dried by any conventionally known method as one for drying a glass substrate, such as spin drying and air-knife drying.

Next, the glass substrate is subjected to texturing. In the texturing here, stripes in the shape of concentric circles are formed on the glass substrate surface by polishing using tape. Texturing gives a magnetic disk medium magnetic anisotropy; this improves the magnetic characteristics thereof as a magnetic disk, and also prevents attraction between a magnetic head and the surface of the magnetic disk when a hard disk drive is out of operation.

Here, a texturing liquid is used that has abrasive particles dispersed evenly in a liquid in a way that the abrasive particles do not precipitate while the liquid is in storage; specifically, used as such a texturing liquid is slurry having about 0.01% to 5% by weight of abrasive particles dispersed in a water solution containing about 1% to 25% by weight of a glycol compound surfactant such as polyethylene glycol or polypropylene glycol.

An example of the abrasive particles is monocrystalline or polycrystalline diamond particles. Diamond particles have a regular particles shape, have a uniform particle size and shape, are hard, and are excellently resistant to chemicals and heat. In particular, polycrystalline diamond particles have, compared with monocrystalline counterparts, a more round particle shape, with rounded corners, and are widely used as abrasive particles for ultraprecision polishing.

It is preferable that, after texturing, the topmost surface of the glass substrate have a surface roughness Ra of 0.3 nm or less. In the magnetic disk as an end product, a surface roughness larger than 0.3 nm here makes it impossible to reduce the distance between a magnetic head and the surface of the magnetic disk, and thus to increase the recording capacity of the magnetic disk.

Next, on the glass substrate fabricated as described above, a magnetic film is formed. The magnetic film can be formed by a conventionally known method, for example, by spin-coating the substrate with a thermosetting resin having magnetic particles dispersed therein, by sputtering, or by electroless plating. Spin-coating provides a film thickness of about 0.3 μm to 1.2 μm, sputtering provides a film thickness of about 0.04 μm to 0.08 μm, and electroless plating provides a film thickness of about 0.05 μm to 0.1 μm. To reduce the film thickness and to obtain a high density, it is preferable to adopt sputtering or electroless plating.

There is no particular restriction on the material of the magnetic film; it may be any conventionally known magnetic material. To obtain a high coercivity, it is suitable to use, for example, an alloy of Co that is based on Co, having high crystal anisotropy, and that has Ni or Cr added thereto to adjust the residual flux density. Specifically, examples of such magnetic materials containing Co as a main ingredient thereof include: CoPt, CoCr, CoNi, CoNiCr, CoCrTa, CoPtCr, CoNiPt, CoNiCrPt, CoNiCrTa, CoCrPtTa, CoCrPtB, and CoCrPtSiO. To reduce noise, the magnetic film may be divided with a non-magnetic film (e.g., Cr, CrMo, or CrV) to have a multiple-layer structure (e.g., CoPtCr/CrMo/CoPtCr, CoCrPtTa/CrMo/CoCrPtTa). Other than the magnetic materials mentioned above, it is also possible to use: a ferrite material; an iron-rare earth metal material; or a granular material having magnetic particles of Fe, Co, FeCo, CoNiPt, or the like dispersed in a non-magnetic film of SiO₂, BN, or the like. The magnetic film may be for either of the longitudinal and perpendicular types of recording.

For smoother sliding of a magnetic head, a thin coat of a lubricant may be applied to the surface of the magnetic film. An example of the lubricant is perfluoropolyether (PFPE), a liquid lubricant, diluted with a solvent of the Freon family or the like.

As necessary, an underlayer or a protective layer may additionally be provided. In a magnetic disk, what underlayer to provide is determined to suit the magnetic film. The material of the underlayer is, for example, one or more selected from the group of non-magnetic metals including Cr, Mo, Ta, Ti, W, V, B, Al, and Ni. With a magnetic film containing Co as a main ingredient thereof, it is preferable to use the simple substance of or an alloy of Cr. The underlayer is not limited to one having a single layer, but may be one having a multiple-layer structure having a plurality of layers of the same material or of different materials laid on one another. Examples of multiple-layer underlayers include: Cr/Cr, Cr/CrMo, Cr/CrV, NiAl/Cr, NiAl/CrMo, and NiAl/CrV.

Examples of protective layers for preventing wear and corrosion of the magnetic film include: a Cr layer, a Cr alloy layer, a carbon layer, a carbon hydride layer, a zirconia layer, and a silica layer. Any of these protective layers can be formed continuously with the underlayer, the magnetic film, etc. on in-line sputtering equipment. Any of those protective layers may be provided in a single layer, or more than one of them, of the same material or of different material, may be provided in multiple layers. In addition to, or instead of, this or these protective layers, another protective layer may be formed. For example, instead of the above protective layers, a silicon dioxide (SiO₂) layer may be formed by applying to the top of the Cr layer minute particles of colloidal silica dispersed in tetraalkoxysilane diluted with a solvent of the alcohol family and then baking the applied layer.

### PRACTICAL EXAMPLE 1 (P. E. 1)

An aluminosilicate glass substrate containing as glass ingredients thereof 66% by weight of SiO₂ and 15% by weight of Al₂O₃ was cleaned by scrubbing on the cleaning equipment shown in FIG. 1 by use of, as a cleaning liquid, one obtained by diluting an alkaline cleaning liquid containing NaOH as a main ingredient thereof with ultrapure water so as to have an Si element stationary of 20 ppb/mm². The cleaning liquid was supplied by being sprayed continuously from three second before the start of scrub-cleaning until the end of scrub-cleaning. The results are shown in Table 1.

### PRACTICAL EXAMPLE 2 (P. E. 2)

A substrate of non-alkali glass containing as glass ingredients thereof 60% by weight of SiO₂, 10% by weight of Al₂O₃, and 10% by weight of B₂O₃ was cleaned by scrubbing on the cleaning equipment shown in FIG. 1 by use of, as a cleaning liquid, one obtained by diluting a cleaning liquid containing sodium silicate as a main ingredient thereof with water processed with a reverse osmosis filtering film (hereinafter referred to as “RO water”) so as to have an Si element stationary of 500 ppb/mm². As with Practical Example 1, the cleaning liquid was supplied by being sprayed continuously from three second before the start of scrub-cleaning until the end of scrub-cleaning. Here, however, before scrub-cleaning, the glass substrate was immersed and transported in the above cleaning liquid. The results are shown in Table 1.

### COMPARATIVE EXAMPLE 1 (C. E. 1)

An aluminosilicate glass substrate containing as glass ingredients thereof 66% by weight of SiO₂ and 15% by weight of Al₂O₃ was cleaned by scrubbing on the cleaning equipment shown in FIG. 1 by use of, as a cleaning liquid, one obtained by diluting an alkaline cleaning liquid containing NaOH as a main ingredient thereof with ultrapure water so as to have an Si element stationary of 10 000 ppb/mm². As with Practical Example 1, the cleaning liquid was supplied by being sprayed continuously from three second before the start of scrub-cleaning until the end of scrub-cleaning. The results are shown in Table 1.

### COMPARATIVE EXAMPLE 2 (C. E. 2)

A substrate of non-alkali glass containing as glass ingredients thereof 60% by weight of SiO₂, 10% by weight of Al₂O₃, and 10% by weight of B₂O₃ was cleaned by scrubbing on the cleaning equipment shown in FIG. 1 by use of, as a cleaning liquid, one obtained by diluting a cleaning liquid containing sodium silicate as a main ingredient thereof with RO water so as to have an Si element stationary of 0.1 ppb/mm². As with Practical Example 2, the cleaning liquid was supplied by being sprayed continuously from three second before the start of scrub-cleaning until the end of scrub-cleaning. Also as with Practical Example 2, before scrub-cleaning, the glass substrate was immersed and transported in the above cleaning liquid. The results are shown in Table 1.

TABLE 1

| | P. Ex. 1 | P. Ex. 2 | C. Ex. 1 | C. Ex. 2 |
|---|---|---|---|---|
| Si Elution (ppb/mm²) | 20 | 500 | 10 000 | 0.1 |
| Foreign Matter Removal | Good | Good | Good | Poor |
| from Substrate Surface | | | | |
| Substrate Surface | Good | Good | Poor | Good |
| Smoothness after Cleaning | | | | |

As will be clear from Table 1, in the glass substrates of Practical Examples 1 and 2, which were scrub-cleaned by the cleaning method of the present invention, no foreign matter was found adhered on the glass substrate surface after cleaning, and the surface of the glass substrate had good smoothness. In contrast, in the glass substrate of Comparative Example 1, which was scrub-cleaned by use of a cleaning liquid having Si element stationary as high as 10 000 ppb/mm², although no foreign matter was found adhered on the glass substrate surface after cleaning, the glass substrate surface had poor smoothness resulting from erosion thereof by the cleaning liquid. In the glass substrate of Comparative Example 2, which was scrub-cleaned by use of a cleaning liquid having Si element stationary as low as 0.1 ppb/mm², although the glass substrate surface had good smoothness after cleaning, foreign matter was found adhered on the glass substrate surface.

What is claimed is:

1. A method for cleaning a glass substrate whereby a glass substrate containing SiO₂ as a main ingredient thereof is cleaned by scrubbing using a cleaning liquid having Si element stationary in a range from 1 to 5 000 ppb/mm².

2. The cleaning method according to claim 1,
wherein the Si element stationary is in a range from 2 to 3 000 ppb/mm².

3. The cleaning method according to claim 1,
wherein the cleaning liquid is hydrofluoric acid.

4. A method for fabricating a glass substrate comprising a cleaning step using the cleaning method according to claim 1.

5. A magnetic disk having a magnetic recording layer formed on a glass substrate fabricated by the fabrication method according to claim 4.
